(19) United States
(12) Patent Application Publication
(10) Pub. No.: US 2018/0121804 A1
(43) Pub. Date: May 3, 2018

(54) Augmented X-Ray Imaging System For Detection of Threats

(71) Applicant: Farrokh Mohamadi, Irvine, CA (US)

(72) Inventor: Farrokh Mohamadi, Irvine, CA (US)

(21) Appl. No.: 15/799,882

(22) Filed: Oct. 31, 2017

Related U.S. Application Data
(60) Provisional application No. 62/415,331, filed on Oct. 31, 2016.

(51) Int. Cl. G06N 3/08; G06T 7/00; G06T 7/44; G06F 17/30

(52) U.S. Cl. CPC G06N 3/08; G06T 7/0004; G06T 7/44; G06T 2207/30112; G06T 2207/20081; G06T 2207/10116; G06F 17/30

(57) ABSTRACT

A pre-trained convolutional neural network is trained to accurately identify threats in x-ray images of luggage. The x-ray images are filtered according to a threshold to separate out the outlines of dense objects prior to the analysis by the trained convolutional neural network.

### CROSS-REFERENCE TO RELATED APPLICATIONS

This application claims the benefit of U.S. Provisional Application No. 62/415,331, filed Oct. 31, 2016.

### TECHNICAL FIELD

This application relates to pattern recognition, and more particularly to the detection of threats using x-ray imaging.

### BACKGROUND

The discrimination of suspicious content in luggage through x-ray imaging is quite challenging since luggage, by its very nature, tends to be crammed with diverse objects that produce considerable clutter in the resulting x-ray images. In addition, mass transportation at airports requires considerable throughput such as the clearing of at least 450 bags per hour for each x-ray imaging system. An alternative to automated analysis of the x-ray images is manual analysis. But human recognition of threats such as guns and knives in x-ray images of luggage has proven to be error-prone, particularly when the threat presents itself in the image in a non-standard profile or orientation and when superimposed against clutter. Moreover, human beings are prone to fatigue and can thus miss threats even when they have been highly trained.

To improve the accuracy and speed for automated x-ray imaging and detection of threats in luggage, the use of a convolutional neural network (CNN) has been studied. But these conventional CNN efforts to detect threats in luggage have not solved the detection problem posed by the clutter and non-standard profile or orientation of a weapon that will commonly occur in the packing of such a weapon into luggage with assorted clothing and other items. Accordingly, there is a need in the art for improved x-ray analysis and detection of weapons or threats in luggage.

### SUMMARY

A weapon detection station is provided for the detection of weapons or threats in luggage. The weapon detection station includes an x-ray system for capturing x-ray images of luggage. The resulting captured data may thus be streamed to the cloud or processed in the weapon detection station itself by a suitable processor such as a graphics processing unit (GPU). The GPU incorporates a pre-trained commercial off-the-shelf (COTS) convolutional neural network (CNN) that is further trained on images of weapons. To address the non-standard orientation problem that will commonly arise with the taking of a two-dimensional (2D) x-ray image of a weapon within luggage, the CNN is also further trained on partial images of weapons.

Each beam within the x-ray system corresponds to the collection of a 2D image. To increase accuracy, a dual-beam (which may also be designated as a dual-energy) x-ray system is used in some embodiments. Regardless of how many beams are employed, the trained CNN does not analyze the original 2D x-ray image corresponding to a particular beam. Instead, the weapons detection station filters the original 2D x-ray image according to a threshold to distinguish relatively dense items from background clutter to address the problems of clutter that is endemic to x-ray imaging of the luggage. Following the filtering, a certain minimum size requirement is applied to filter out dense objects that are too small to constitute a weapon. The resulting disconnected dense objects are then placed in separate image bins for processing by the trained CNN. To further increase accuracy, the prediction results from the separate beams in dual-beam embodiments are combined.

These and other advantageous features may be better appreciated through the following detailed description.

### BRIEF DESCRIPTION OF THE DRAWINGS

FIG. 1 is a diagram of an example weapon detection system in accordance with an aspect of the disclosure.

FIG. 2 illustrates an example image database for the training of a pre-trained CNN in the weapon detection system of FIG. 1.

FIG. 3 illustrates the thresholding of x-ray images prior to the CNN processing to increase the accuracy of the CNN detection of weapons in the resulting threshold-applied x-ray images.

FIG. 4 illustrates the application of the trained CNN onto x-ray images of luggage for weapon detection.

Embodiments of the present disclosure and their advantages are best understood by referring to the detailed description that follows. It should be appreciated that like reference numerals are used to identify like elements illustrated in one or more of the figures.

### DETAILED DESCRIPTION

To quickly and accurately detect weapons in luggage, a commercial off-the shelf (COTS) pre-trained convolutional neural network (CNN) is exploited by further training the CNN on images not related to the images for its pre-training. In particular, images of weapons such as handguns and knives were used to provide this further training. As a control to guard against false detection, the CNN is also trained on images of an innocuous item that is similarly shaped to a knife such as a shoe having stiletto heels or a wrench. In addition, the CNN is also trained on partial images of knives and handguns. Such partial image training is quite advantageous in that the clutter that is endemic to the hand-packing of luggage with various and sundry items can often obscure the outline of a weapon. Yet certain features such as the trigger in a handgun or the sharpened point of a knife are quite distinctive even when viewed in isolation. The partial image training of the CNN thus enables the resulting trained CNN to spot weapons even when the object is partially obscured by clutter. The partial image training is also quite advantageous with regard to identifying a weapon when viewed in a non-standard orientation. As compared to traditional uses of x-ray to manually detect weapons, the resulting detection has much greater accuracy yet requires relatively little computing complexity. For example, accuracies of 97% or greater were achieved in distinguishing between various types of handguns and knives as compared to non-weapons such as wrenches or other types of household items.

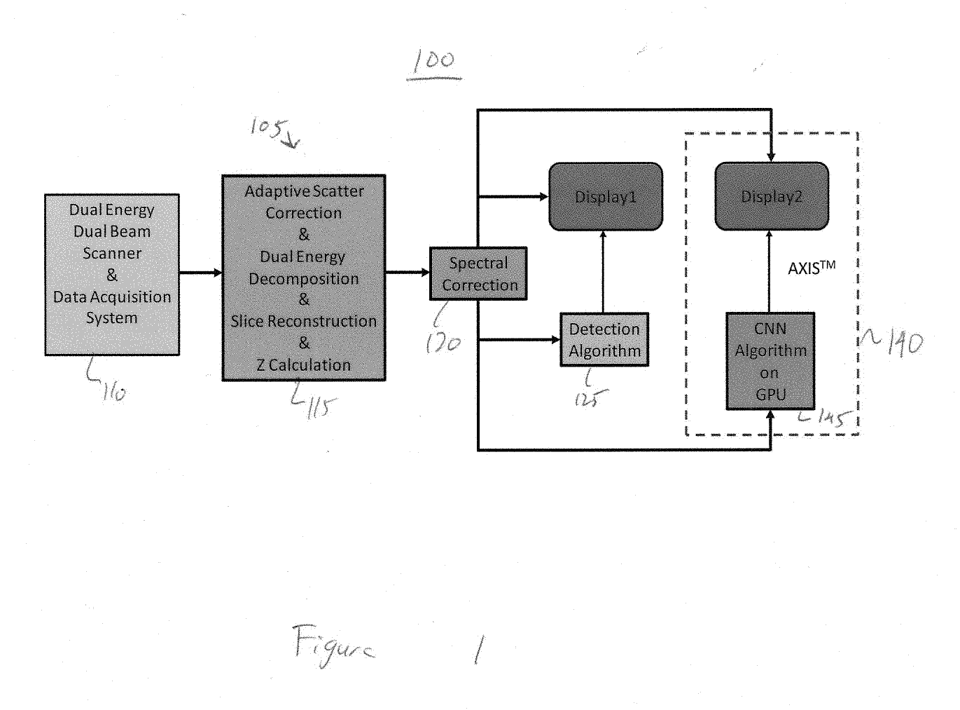

An example weapon detection station 100 is shown in FIG. 1. Any commercially-available-off-the-shelf (COTS) x-ray imaging system 105 may be used within weapon detection system 100, such as developed by Astrophysics, L3 Communication, Analogic, Rapiscan, or Smiths Detection. In station 100, x-ray imaging system 105 includes a dual energy/dual beam x-ray scanner and data acquisition system 110 that performs an adaptive scatter correction, dual energy decomposition, slice reconstruction, and Z calculation 115. The Z calculation refers to the calculation of an effective atomic weight (Z) for the pixels within the resulting 2D x-ray image produced by system 110. X-ray imaging system 105 also performs a spectral correction technique 120 using copper filters as known in the x-ray imaging arts. After performing a detection algorithm 125 using standard machine vision techniques, the resulting x-ray image or slices are displayed on a first display (Display 1) so that, for example, a TSA employee may perform a manual analysis of the image.

To enhance accuracy and automate weapon detection, x-ray imaging system 105 is integrated with a CNN system 140 that includes a suitable processor such as a GPU 145 for performing a CNN algorithm on the x-ray images. Examples of suitable GPUs include the NVidia K80/40 GPU and related models. Should a weapon or other form of security threat be detected, it is then highlighted by CNN system 140 on a second display (Display2). In alternative embodiments, the first and second displays may comprise a single integrated display. Advantageously, it has been discovered that remarkable accuracy may be achieved through the use of COTS convolutional neural networks such as the MatLab-based “AlexNet” CNN. Such COTS CNNs are typically pre-trained on the “ImageNet” database, which has 1,000 object categories over approximately 1.2 million images.

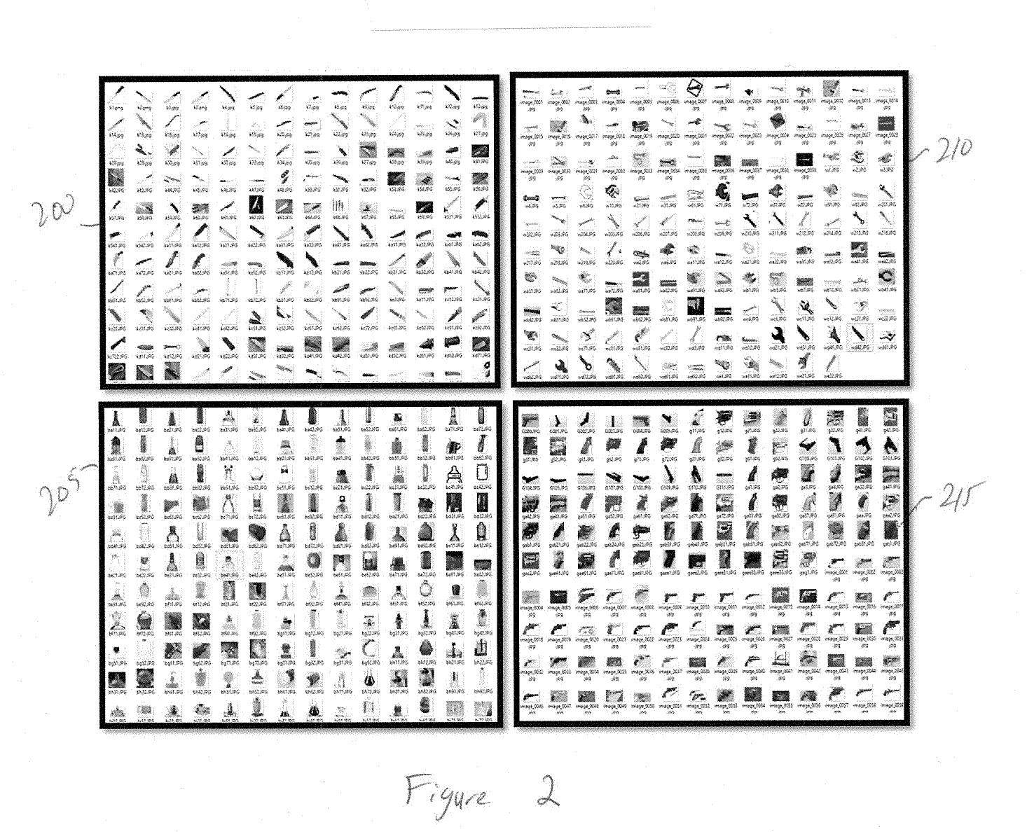

The pre-trained CNN as programmed into GPU 145 is further trained as shown in FIG. 2. The CNN is pre-trained by its developer using an image set such as the ImageNet image database discussed above. The pre-trained CNN is then trained on the desired image categories. In this embodiment, the training set included three different threats. In particular, the training set of images included knife images 200, liquid-containing bottle images 205, and handgun images 215. To further improve the accuracy of detection for knives as compared to similarly-shaped innocuous items, the training set also included images of household items such as wrenches 210. As noted earlier, the x-ray imaging of luggage results in considerable clutter as various metallic or other dense items may be jumbled or mixed with weapons. The resulting imaging of the weapon or threat thus often results in an outline of a composite item that includes the threat. But it has been discovered herein that portions of weapons have very distinctive shapes that the CNN may be readily trained to recognize. For example, the trigger and handle of a handgun are distinctive and repeated across various handgun types such as revolvers and automatics. Similarly, the point of a knife is quite distinctive and repeated across various types of knives such as a dagger or a stiletto. Knife images 200 thus not only contain complete images of knives from many different orientations but also partial images of knives that do not show the complete outline of the weapon. Similarly, gun images 215 and liquid-containing bottle images 205 also contain partial images. Note that the image training set may contain other images of items one would typically include in luggage such as images of shoes to further increase the accuracy of weapon detection as compared to false positive identification of such innocuous household items.

To further increase accuracy of the resulting CNN image processing, the images within the desired categories for additional training of the pre-trained CNN may be refined by the removal of those images that were not correctly identified. Should some unseen images be incorrectly identified, they are removed from the training image database, whereupon the pre-trained CNN is re-trained on the refined database of images. Conversely, the training database of images is enhanced by the inclusion of unseen images that are correctly identified. Such recursive correction of the training database may be performed manually or may be automated.

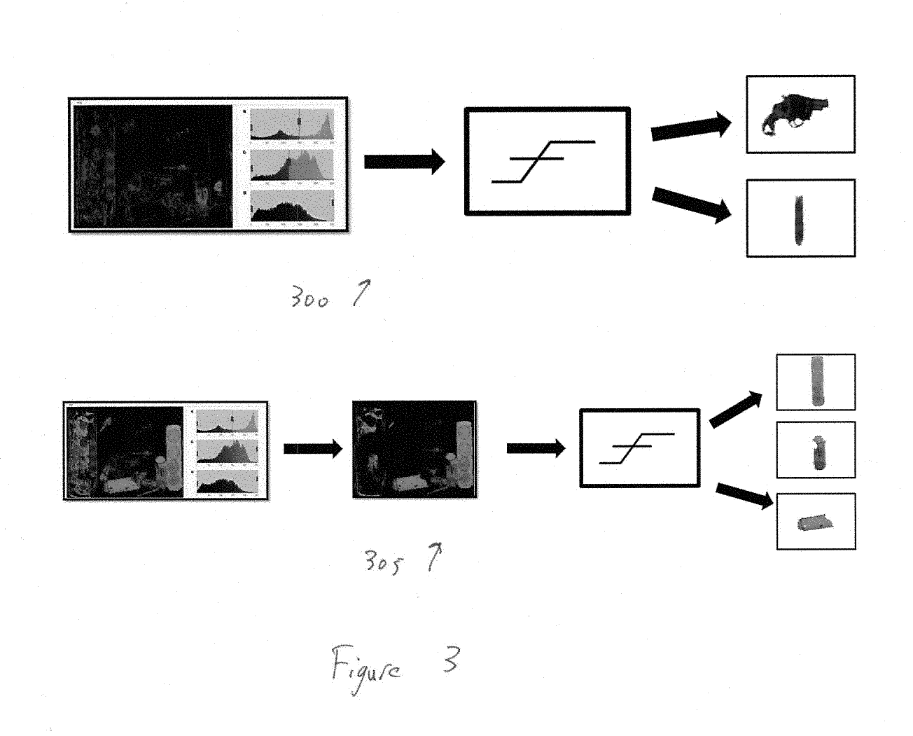

With the pre-trained CNN trained on the training set of images, weapon detection station 100 is then ready to detect weapons in the resulting x-ray images of luggage. Note that is conventional for an x-ray imaging system such as system 105 to layer the x-ray images into different color layers for the enhanced manual inspection of the layered x-ray images such as by TSA personnel. For example, the x-ray image is separated into layers based upon the density of the objects within the x-ray images. A dense layer (such as given the color blue) is then filtered according to threshold process 300 as shown in FIG. 3 to separate out the dense metallic items that are disconnected in the image (or are disconnected based upon their joint contour) that not only pass the thresholding but also satisfy a minimum size requirement. The edges of the separated items may then be smoothed such as by Gaussian filtering. The smoothed separated item (or items) from the thresholding of the x-ray image are placed into separate image bins for CNN analysis. Also shown in FIG. 3 is the thresholding 305 of the less dense image layer to separate out liquid-containing bottles. The resulting separated items are then smoothed and placed into separate image bins for a subsequent CNN analysis as discussed for thresholding 300.

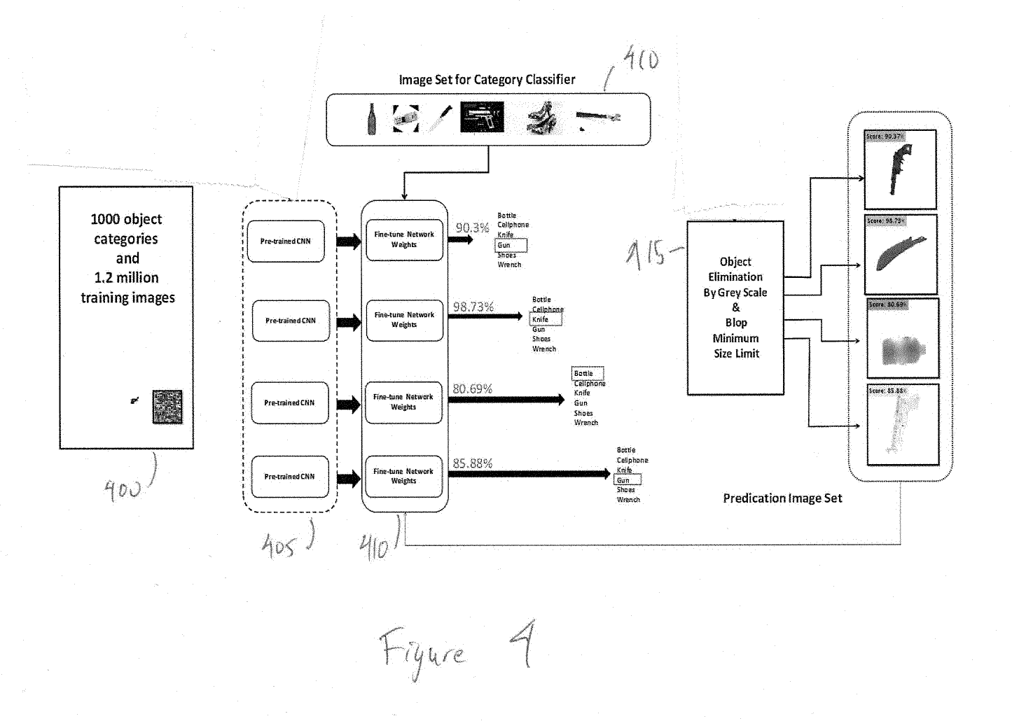

The CNN analysis following the thresholding is shown in FIG. 4. The COTS CNN is pre-trained on a commercial image database 400 as discussed previously to form a pre-trained CNN 405. The neurons within pre-trained CNN 405 are fine-tuned responsive to an image set 410 as discussed previously. Image set 410 contains images and partial images of handguns, knives, and liquid-containing bottles. In addition, image set 410 contains images of household items such as shoes and wrenches. The resulting trained CNN can then distinguish between these threats with advantageous accuracy such as 80.69% or even higher such as 98.73%. Such accuracy exceeds in general the accuracy of trained personnel manually inspecting the same x-ray images. Trained CNN 410 may then be applied to x-ray images processed by a thresholding and minimum size limit process 415 to identify the various threats. Feedback from this identification may be used to further fine-tune the training of trained CNN 410. Should x-ray imaging system 105 be a dual-beam system that produces an x-ray image of luggage in various planes, the CNN analysis of the item outlines that result from the thresholding and filtering by size in one plane may be combined with the results from another plane to further increase the accuracy of detection.

It will be appreciated that many modifications, substitutions and variations can be made in and to the materials, apparatus, configurations and methods of use of the devices of the present disclosure without departing from the scope thereof For example, the thresholding and CNN analysis may be done locally at the weapon detection station or may be performed in the cloud. In light of this, the scope of the present disclosure should not be limited to that of the particular embodiments illustrated and described herein, as they are merely by way of some examples thereof, but rather, should be fully commensurate with that of the claims appended hereafter and their functional equivalents.

I claim:

1. A system for identifying weapons in luggage, comprising:
an x-ray imaging system for producing x-ray images of luggage;
a processor configured to apply a threshold to the x-ray images to separate out outlines of dense objects that pass the threshold; and
a convolutional neural network for analyzing the outlines of the dense objects to identify weapons in the x-ray images.

2. The system of claim 1, wherein the convolutional neural network is a pre-trained convolutional neural network.

3. The system of claim 2, wherein the pre-trained convolutional neural network is further trained on a database of images of knives and handguns.

4. The system of claim 3, wherein the database of images of knives and handguns include partial images of the knives and handguns that do not include a complete outline of the knives and handguns.

5. The system of claim 1, wherein the x-ray imaging system is a dual-beam x-ray imaging system.

6. The system of claim 1, wherein the processor is further configured to apply a minimum size requirement to the separated items.

7. The system of claim 6, wherein the processor is further configured to apply a smoothing filter to the outlines of the separated items.

8. The system of claim 7, wherein the smoothing filter is a Gaussian filter.

9. The system of claim 1, wherein the convolutional neural network further comprises a graphics processing unit.

10. A method, comprising:
obtaining a pre-trained convolutional neural network that is pre-trained on an image database that does not include images of knives and handguns;
training the pre-trained convolutional neural network on a database of knife and handgun images to provide a trained convolutional neural network that distinguishes between knives and handguns;
x-raying luggage to produce x-ray images of the luggage; and
identifying knives and handguns in the x-ray images using the trained convolutional neural network.

11. The method of claim 10, wherein training the pre-trained convolutional neural network comprises a recursive training in which incorrectly-identified unseen images of knives and handguns are not added to the database, and wherein correctly identified unseen images are added to the database.

12. The method of claim 10, wherein training the pre-trained convolutional neural network comprises further training the pre-trained convolutional neural network on partial images of knives and handguns that do not contain a complete outline of the knives and handguns.

13. The method of claim 12, training the pre-trained convolutional neural network comprises further training the pre-trained convolutional neural network on images of just a handgun trigger.

14. The method of claim 10, wherein x-raying the luggage comprising producing a first x-ray image across a first plane for the luggage and producing a second x-ray image in a different plane for the luggage.

15. The method of claim 10, wherein identifying knives and handguns in the x-ray images using the trained convolutional neural network occurs in a processor remote from the x-raying of the luggage.

16. The method of claim 15, further comprising:
applying a threshold to the x-ray images to separate out an outline of dense objects within the x-ray images, wherein identifying knives and handguns in the x-ray images using the trained convolutional neural network comprises using the trained convolutional neural network on the outlines of the dense objects.
